(19) United States
(12) Patent Application Publication
(10) Pub. No.: US 2019/0057122 A1
(43) Pub. Date: Feb. 21, 2019

(54) Systems and methods for data ingestion

(71) Applicant: JPMorgan Chase Bank, N.A., New York, NY (US)

(72) Inventors: Lana Kapulovskaya, New York, NY (US); Satish Jonnavithula, Plainsboro, NJ (US)

(21) Appl. No.: 15/998,666

(22) Filed: Aug. 15, 2018

Related U.S. Application Data
(60) Provisional application No. 62/545,525, filed on Aug. 15, 2017.

(51) Int. Cl. G06F 17/30

(52) U.S. Cl. CPC G06F 17/30336; G06F 17/3033

(57) ABSTRACT

Systems and methods for data ingestion are disclosed. According to one embodiment, in an information processing device comprising at least one computer processor, a method for data ingestion may include: (1) comparing current metadata for data in a data source to a prior metadata for data the data source to identify a change in a data structure or a new data structure for stored data stored in a target platform; (2) determining that the data structure for the data has changed; (3) changing the data structure or creating a new data structure on the target platform to confirm to the data structure; (4) dynamically conforming the data in the data source to the new data structure; and (5) dynamically extracting and loading the data from the data source to the target platform.

### RELATED APPLICATIONS

This application claims priority to U.S. Provisional Patent Application Ser. No. 62/545,525, filed Aug. 15, 2017, the disclosure of which is hereby incorporated, by reference, in its entirety.

### BACKGROUND OF THE INVENTION

### 1. Field of the Invention

The present disclosure generally relates to systems and methods for data ingestion.

### 2. Description of the Related Art

A data analytics platform requires a fast, agile, and highly adaptive approach for acquiring and enabling data for analytics. Data replication brings various challenges, as the data sources may change not only their data volumes, but also their schemas, their semantics, and their query capabilities. When a data structure and mapping is left inconsistent by a schema change, it has to be detected and synchronized quickly to avoid data discrepancies and load failures.

### SUMMARY OF THE INVENTION

Systems and methods for data ingestion are disclosed. According to one embodiment, in an information processing device comprising at least one computer processor, a method for data ingestion may include: (1) comparing current metadata for data in a data source to a prior metadata for data the data source to identify a change in a data structure or a new data structure for stored data stored in a target platform; (2) determining that the data structure for the data has changed; (3) changing the data structure or creating a new data structure on the target platform to confirm to the data structure; (4) dynamically conforming the data in the data source to the new data structure; and (5) dynamically extracting and loading the data from the data source to the target platform.

In one embodiment, the metadata for the data in the data source may include a current capture of the metadata for the data in the data source.

In one embodiment, the prior version of the metadata may be stored in a metadata repository.

In one embodiment, the step of dynamically changing the data structure or creating a new data structure on the target platform to confirm to the data structure may include generating at least one DDL script to conform the data structure on the target platform to the new or changed data structure for the data in the data source.

In one embodiment, the method may further include identifying a manner of loading the data in the data source based on a volume of the data in the data source that has changed.

In one embodiment, the manner of loading the data in the data source may include a bulk load, a plurality of parameter-based sessions, a plurality of threads, etc.

In one embodiment, the method may further include calculating a hash value for each data record in the data source; comparing the hash value for each data record to a stored hash value for the data record; and identifying data records for loading when the hash value for the data record does not match the stored hash value for that record. The hash value for the data record not matching the stored hash value for that record may indicate that the data record is new, changed, or deleted.

According to another embodiment, a system for data ingestion, may include a data source; a metadata repository; an ingestion engine comprising at least one computer processor; and a target platform. The ingestion engine may compare current metadata for data in the data source to a prior metadata for data the data source stored in the metadata repository to identify a change in a data structure or a new data structure for stored data stored in the target platform; determine that the data structure for the data has changed; change the data structure or creating a new data structure on the target platform to confirm to the data structure; dynamically conform the data in the data source to the new data structure; and dynamically extract and load the data from the data source to the target platform.

In one embodiment, the metadata for the data in the data source may include a current capture of the metadata for the data in the data source.

In one embodiment, the ingestion engine may generate at least one DDL script to conform the data structure on the target platform to the new or changed data structure for the data in the data source.

In one embodiment, the ingestion engine may identify a manner of loading the data in the data source based on a volume of the data in the data source that has changed.

In one embodiment, the manner of loading the data in the data source may include a bulk load, a plurality of parameter-based sessions, a plurality of threads, etc.

In one embodiment, the ingestion engine may calculate a hash value for each data record in the data source, compares the hash value for each data record to a stored hash value for the data record, and identifies data records for loading when the hash value for the data record does not match the stored hash value for that record. In one embodiment, the hash value for the data record not matching the stored hash value for that record may indicate that the data record is new, changed, or deleted.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for data ingestion according to one embodiment; and

FIG. 2 depicts a method for data ingestion according to one embodiment.

### DETAILED DESCRIPTION OF PREFERRED EMBODIMENTS

Embodiments disclosed herein relate to a digital ingestion framework.

Embodiments disclosed herein involve a dynamic, metadata driven approach to data loading. In embodiments, the system and method may detect mappings affected by physical changes in a data source, and may dynamically generate and execute all the rewritings (e.g., Data Definition Language, or DDL) on a data warehouse that are consistent with the semantics of the changed objects in the data source. The framework may also dynamically detect the load method (e.g., bulk load) based on volume to ensure optimal load performance. Embodiments may capture and apply historical changes through the in-memory hashing algorithm while loading data into the data warehouse.

Embodiments may provide some or all of the following technical advantages: (1) automate the processes of schema changes, mappings and ETL; (2) reduce development cost and minimize Business as Usual (BAU) cycles; (3) eliminate data discrepancies and load failures due to changed data structures; (4) simplify code base by replacing hundreds of ETLs by single codebase; (5) deliver a fast and scalable Change Data Capture (CDC) solution; (6) provide dynamic detection of the most optimal load method; and (7) provide a fully automated reconciliation process.

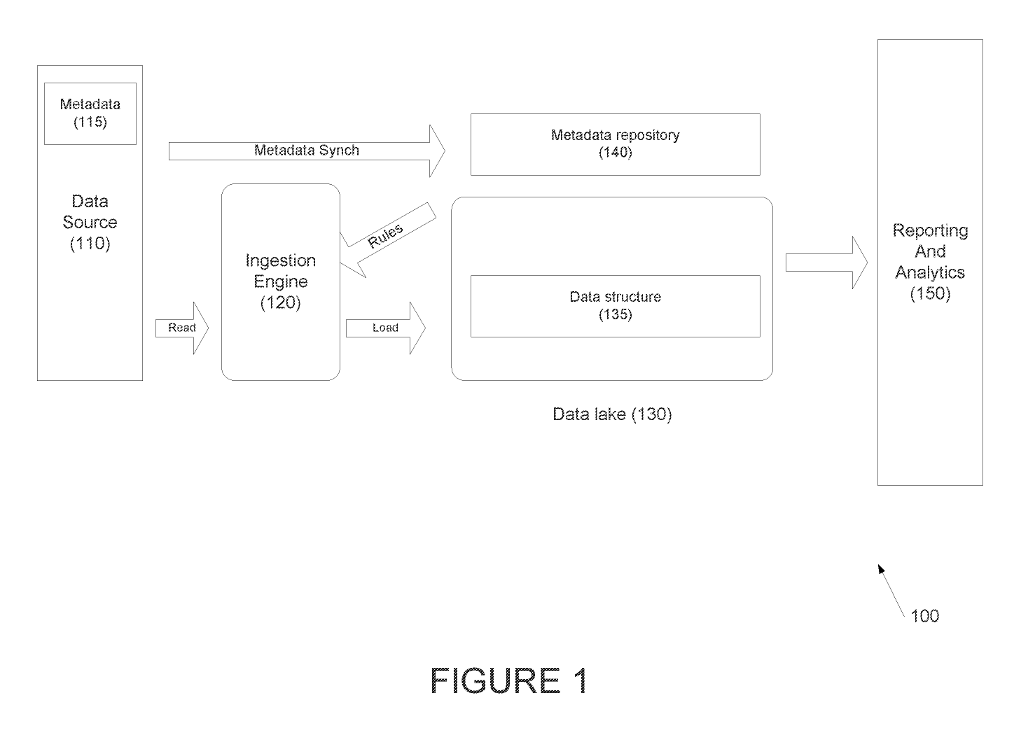

Referring to FIG. 1, a system for data ingestion is disclosed according to one embodiment. System 100 may include one or more data source(s) 110, ingestion engine 120, data lake 130, metadata repository 140, and reporting and analytics 150. In one embodiment, data source 110 may be any suitable source of data, including customer relationship management software such as SalesForce.

Other examples of data source 110 include Salesforce Marketing Cloud, Relational Databases such as Oracle, File Input, Enterprise Reference data (JSON), Google Analytics (Big Query) data, etc. Any other suitable data source may be used as is necessary and/or desired.

In one embodiment, data source 110 may be internal to an organization, external to an organization, from a private or public cloud, etc. Data from data source 110 may be structured, unstructured, or semi-structured.

In one embodiment, data source 110 may maintain metadata 115 associated with its data. In one embodiment, data source 110 may provide metadata 115; in another embodiment, data source 110 may not provide metadata 115, and metadata 115 may be generated via an onboarding process.

System 100 may include ingestion engine 120. Ingestion engine may perform data collection, capture changes, define, create, or change target data structure 135, and may use metadata 115 to dynamically determine a load process for data in data source 110.

System 100 may include data lake 130. Data lake may store data from data source 110. In one embodiment, data lake 130 may include data structure 135 in which data from data source 130 may be loaded.

Examples of data lake 130 include Greenplum, Oracle, Impala/Hive on Hadoop, etc.

Metadata repository 140 may store one or more recent copies of metadata 115 from data source 110, or may generate metadata for data in data source 110 if metadata 115 is not provided.

Reporting and analytics layer 150 may provide an interface for a user to access data in data lake 130.

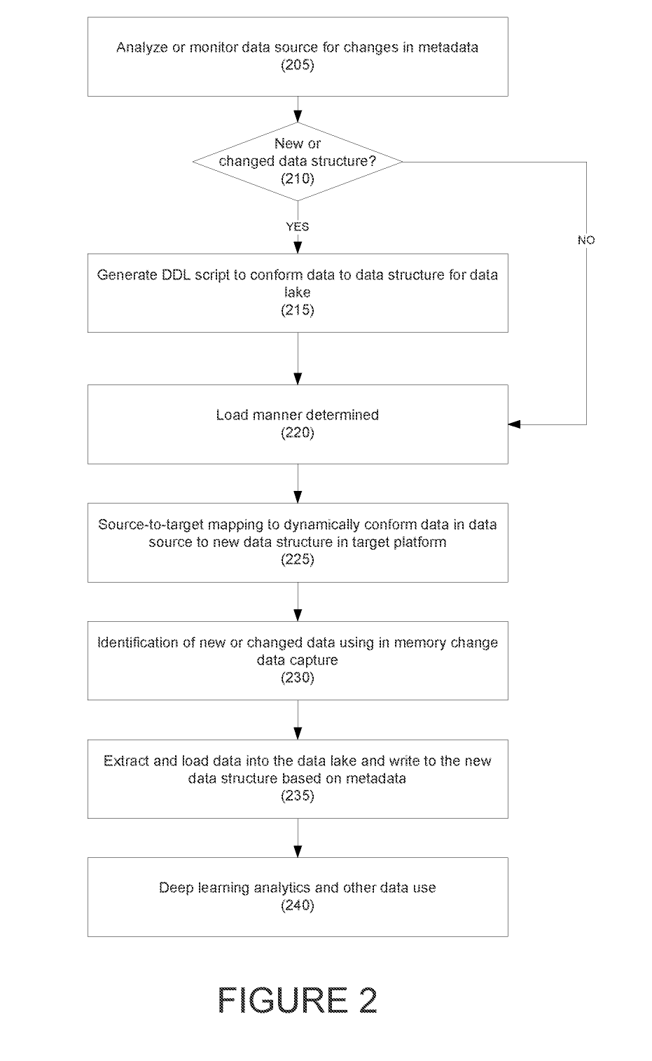

Referring to FIG. 2, a method for data ingestion is disclosed according to one embodiment. In step 205, a metadata for data stored in a data source may be monitored and/or analyzed for changes in metadata. For example, a current capture of the metadata may be compared to a prior capture of the metadata that may be maintained in, for example, a metadata repository.

For example, a module for an ingestion engine that may be built in Pentaho may make a service call to a data source, such as Salesforce, for the most recent metadata.

In another embodiment, if metadata is not provided by the data source, metadata may be generated.

If, in step 210, the metadata for the data in the data source may be compared to prior metadata for the data in the data source to identify a new data structure or a change in the data structure for the data. The stored metadata may be stored in, for example, a metadata repository. If a new or changed data structure is identified, in step 215, a dynamic Data Definition Language (DDL) script may be generated and executed by a target platform to conform to a data structure used to store data in the data lake. For example, the DDL scripts (e.g., create new object, alter existing object, etc.) may be automatically generated and executed on target database to prepare for loading.

In one embodiment, if the comparison indicates that the data structure has not changed, the process continues to step 220.

In step 220, the manner in which data is loaded may be determined based on the volume of data that will be ingested. In one embodiment, the engine may dynamically detect the size of the objects and may select a bulk load method if the object is too large.

In one embodiment, the load method may be dictated by the metadata.

For example, using recent metadata, the batch may generate multiple, parameter based sessions. Based on the batch size, the load method may be adjusted to bulk load.

In step 225, source to target mapping may be performed to dynamically conform the data in the data structure to the new data structure in the target based on the metadata.

In step 230, for each record in the data source, a hash value or similar value may be compared to an existing hash value or similar value for the data record to identify data records that are new, have changed, or are deleted so that only new or changed data records are loaded. Deleted records may be deleted.

In step 235, based comparison in step 230, new or change data may be extracted and loaded from the data source to the target platform using the new target data structure. For example, based on the metadata and the load rules (e.g., both static and dynamic), the ingestion framework may read data from the source system and proceed with transferring data to the target platform into the new data structure.

For example, in one embodiment, the data load module may dynamically load multiple objects simultaneously. In one embodiment, the data load module may use multiple threads to load the objects.

In one embodiment, the load process may be a single code base that spins dynamic, parallel, multi-threaded load jobs based on the changed metadata.

The batch may further support monitoring and error handling.

In one embodiment, in step 240, once in the data lake, the data may be used for reporting, abstraction, or may be provided to other applications and entities. In addition, deep analytics may be performed on the data in the data structure. This may be performed using an interface for individuals and applications to access the data and/or metadata.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for data ingestion, comprising:
in an information processing device comprising at least one computer processor:
comparing current metadata for data in a data source to a prior metadata for data the data source to identify a change in a data structure or a new data structure for stored data stored in a target platform;
determining that the data structure for the data has changed;
changing the data structure or creating a new data structure on the target platform to confirm to the data structure;
dynamically conforming the data in the data source to the new data structure; and
dynamically extracting and loading the data from the data source to the target platform.

2. The method of claim 1, wherein the metadata for the data in the data source comprises a current capture of the metadata for the data in the data source.

3. The method of claim 1, wherein the prior version of the metadata is stored in a metadata repository.

4. The method of claim 1, wherein the step of dynamically changing the data structure or creating a new data structure on the target platform to confirm to the data structure comprises:
generating at least one DDL script to conform the data structure on the target platform to the new or changed data structure for the data in the data source.

5. The method of claim 1, further comprising:
identifying a manner of loading the data in the data source based on a volume of the data in the data source that has changed.

6. The method of claim 5, wherein the manner of loading the data in the data source comprises a bulk load.

7. The method of claim 5, wherein the manner of loading the data in the data source comprises a plurality of parameter-based sessions.

8. The method of claim 1, wherein the manner of loading the data in the data source comprises a plurality of threads.

9. The method of claim 1, further comprising:
calculating a hash value for each data record in the data source;
comparing the hash value for each data record to a stored hash value for the data record; and
identifying data records for loading when the hash value for the data record does not match the stored hash value for that record.

10. The method of claim 9, wherein the hash value for the data record not matching the stored hash value for that record indicates that the data record is new, changed, or deleted.

11. A system for data ingestion, comprising:
a data source;
a metadata repository;
an ingestion engine comprising at least one computer processor; and
a target platform;
wherein:
the ingestion engine compares current metadata for data in the data source to a prior metadata for data the data source stored in the metadata repository to identify a change in a data structure or a new data structure for stored data stored in the target platform;
the ingestion engine determines that the data structure for the data has changed;
the ingestion engine changes the data structure or creating a new data structure on the target platform to confirm to the data structure;
the ingestion engine dynamically conforms the data in the data source to the new data structure; and
the ingestion engine dynamically extracts and loads the data from the data source to the target platform;

12. The system of claim 11, wherein the metadata for the data in the data source comprises a current capture of the metadata for the data in the data source.

13. The system of claim 11, wherein the ingestion engine generates at least one DDL script to conform the data structure on the target platform to the new or changed data structure for the data in the data source.

14. The system of claim 11, wherein the ingestion engine identifies a manner of loading the data in the data source based on a volume of the data in the data source that has changed.

15. The system of claim 14, wherein the manner of loading the data in the data source comprises a bulk load.

16. The system of claim 14, wherein the manner of loading the data in the data source comprises a plurality of parameter-based sessions.

17. The system of claim 14, wherein the manner of loading the data in the data source comprises a plurality of threads.

18. The system of claim 11, wherein the ingestion engine calculates a hash value for each data record in the data source, compares the hash value for each data record to a stored hash value for the data record, and identifies data records for loading when the hash value for the data record does not match the stored hash value for that record.

19. The system of claim 18, wherein the hash value for the data record not matching the stored hash value for that record indicates that the data record is new, changed, or deleted.
